(19) United States
(12) Patent Application Publication
(10) Pub. No.: US 2007/0214424 A1
(43) Pub. Date: Sep. 13, 2007

(54) Networked chat technique

(75) Inventors: Esther Gilead, Haifa (IL); Michal Jacovi, Rakefet (IL); Natalia Marmasse, Kibbutz Givat Haim Ichud (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/374,244

(22) Filed: Mar. 13, 2006

(51) Int. Cl. G06F 3/00; G06F 15/16

(52) U.S. Cl. 715/758; 709/204

(57) ABSTRACT

Chat conversations are managed in a networked chat communications system, in which facilities are provided for reordering a stream of chat messages. Options are provided to emphasize messages of importance by visual and audio effects, and to de-emphasize messages of lesser importance. Changes in a window display may be propagated to and reflected in display windows of other chat participants.

### BACKGROUND OF THE INVENTION

1. Field of the Invention

This invention relates to instant messaging sessions in computer networks. More particularly, this invention relates to organization of statements in a chat session.

2. Description of the Related Art

Instant messaging (chat) is an online activity, which has become increasingly popular among Internet users. In chat environments, users communicate with each other, and collaborate in real time over a networked data processing system. Instant messaging applications monitor and report the status of users that have established each other as online contacts. This information is typically presented in a window of a display.

### SUMMARY OF THE INVENTION

An embodiment of the invention provides a computer-implemented method of chat communication, which is carried out by displaying a sequence of chat communication messages in a window of a screen, and reordering the sequence of the chat communication messages in the window to create a new window display. Reordering is accomplished by relocating selected ones of the chat communication messages to desired positions. The method is further carried out by propagating the new window display to others of the participants in the chat communication.

According to an aspect of the method, reordering the sequence of chat communication messages is carried out by relocating the selected ones of the chat communication messages with respect to others of the chat communication messages.

One aspect of the method includes identifying the selected ones of the chat communication messages by an ancillary visual indicator in the window, wherein the ancillary visual indicator is not present in the window during periods in which reordering is not being performed, and transmitting control messages to the other participants indicative of the reordering.

In another aspect of the method, reordering comprises actuating window controls that are respectively associated with the chat communication messages.

In a further aspect of the method, reordering includes right-clicking on the chat communication messages to display a popup menu, and selecting a relocation option from the popup menu.

According to yet another aspect of the method, the participants in the chat communication comprise clients that are linked to a server in a data network.

An embodiment of the invention provides a method of chat communication among participants, which is carried out by displaying chat communication messages in a window, visually emphasizing selected ones of the chat communication messages in the window to create a new window display, and propagating the new window display to other participants in the chat communication.

A further aspect of the method includes identifying the selected ones of the chat communication messages on the new window display by triggering audio effects that are perceptible by the participants.

In an aspect of the method, emphasizing comprises actuating controls on the window that are respectively associated with the chat communication messages.

In one aspect of the method, emphasizing comprises right-clicking on the chat communication messages to display a popup menu and selecting an emphasis option from the popup menu.

In another aspect of the method, emphasizing comprises varying a font style of the selected ones of the chat communication messages.

In yet another aspect of the method, emphasizing chat communication messages comprises varying a color of the selected ones of the chat communication messages.

An embodiment of the invention provides a method of chat communication among participants, which is carried out by displaying chat communication messages in a window, visually de-emphasizing selected ones of the chat communication messages in the window to create a new window display, and propagating the new window display to others of the participants in the chat communication.

In an aspect of the method, de-emphasizing comprises graying-out the selected ones of the chat communication messages.

In one aspect of the method, de-emphasizing comprises varying a font style of the selected ones of the chat communication messages.

In still another aspect of the method, de-emphasizing comprises varying a color of the selected ones of the chat communication messages.

An embodiment of the invention provides a computer software product for conducting chat communication among participants, including a computer-readable medium in which computer program instructions are stored, which instructions, when read by a computer, cause the computer to display a sequence of chat communication messages in a window of a screen, to reorder the sequence of the chat communication messages in the window, to create a new window display by selecting the chat communication messages and relocating the selected ones of the chat communication messages to desired positions with respect to others of the chat communication messages, and to propagate the new window display to at least a portion of the participants in the chat communication.

An embodiment of the invention provides a data processing system for chat communication, including a client device linked to other devices via a server in a data network, wherein the server is operative to automatically distribute data among the client device and the other devices, a memory accessible by the client device, and a software program in the memory including program instructions. The instructions, when read by the client device, cause the client device to display a sequence of chat communication messages in a window, to enable a user of the client device to reorder the sequence of the chat communication messages in the window, to create a new window display by selecting the chat communication messages and relocating the selected ones of the chat communication messages to desired positions with respect to others of the chat communication messages, and to propagate the new window display to at least a portion of the other devices via the data network.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is an illustration of a networked data processing system to which the principles of the invention are applied;

FIG. 2 is a pictorial diagram illustrating a window of a display showing a fragment of a chat transcript, in accordance with a disclosed embodiment of the invention;

FIG. 3 is a pictorial diagram showing the chat transcript illustrated in FIG. 2 in which messages have been relocated, in accordance with a disclosed embodiment of the invention;

FIG. 4 is a pictorial diagram showing emphasis and de-emphasis of messages in the chat transcript illustrated in FIG. 2, in accordance with a disclosed embodiment of the invention; and

FIG. 5 is a flow chart illustrating a method of networked chat management in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

Definitions.

As used herein, the term “right-click” means to press and release a button on the mouse or activate another user control assigned to ancillary functions. The term “left-click” means to press and release a mouse button or activate another user control assigned to primary functions. Typically, by right-clicking, a user is able to view properties, or the status of an object, and to select specialized functions, and various context specific options. The terms “left-click” and “right-click” are used solely for convenience and do not necessarily correspond to the physical locations of the controls that are used to perform these functions.

Overview.

Basic issues with chat client interfaces and the way in which chat text and other information is presented limit the utility of chat applications, tending to exclude more formal interactions among users. Standard forms of chat introduce ambiguity into user interactions in a number of ways. Perhaps the most profound ambiguity results from the disruptive manner in which chat messages are displayed within a chat client. As chat conveys information immediately and is designed to be “light-weight”, in that formal organization of communications are minimized, sentences are often exchanged rather quickly, and without troubling to specify the exact context.

In some chat clients, chat messages are displayed in the order they are received by the chat client. In consequence, listed chat messages may have a chronological order, but do not have any further logical ordering that would assist one to follow a given conversation easily. The problem exists even in a single thread, in which different response times by participants can result in messages appearing out of order on a display, because chat messages are posted in the order they are received.

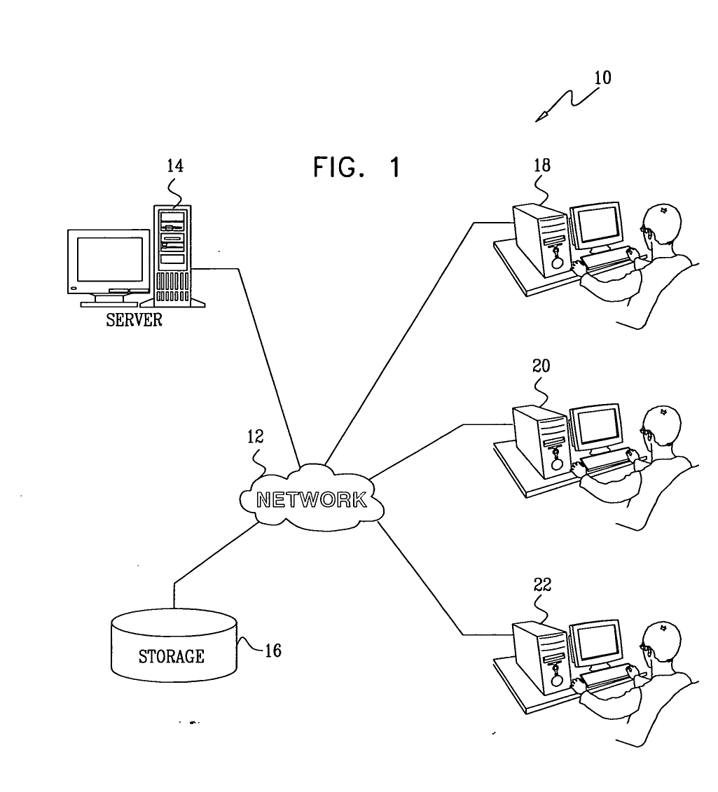

Turning now to the drawings, reference is initially made to FIG. 1, which is an illustration of a networked data processing system 10 to which the principles of the invention are applied. The system 10 is linked with a network 12, which is the medium used to provide communications links between various devices and computers or other communications devices connected together within the system 10. The network 12 may include connections, such as wire, wireless communication links, or fiber optic cables. The system 10 is not meant as an architectural limitation. Rather, the principles of the invention are applicable to many types of public and private networks and configurations of computers and servers.

In the depicted example, the network 12 is the Internet, and represents a worldwide collection of networks and gateways that use the Transmission Control Protocol/Internet Protocol (TCP/IP) suite of protocols to communicate with one another. Of course, the system 10 also may be implemented with a number of different types of networks, for example, an intranet, a local area network (LAN), or a wide area network (WAN).

A server 14 is connected to the network 12 along with a storage unit 16. In addition, any number of clients of the server 14, shown representatively in FIG. 1 as clients 18, 20, 22, are concurrently connected to the network 12. The clients 18, 20, 22 may be, for example, personal computers, network terminals, or various types of wireless devices, such as personal digital assistants (PDA's) or cellular telephones. In any case, the clients 18, 20, 22 are provided with suitable memory for executing program instructions that support the functions and activities detailed below. In the depicted example, the server 14 may provide data, such as boot files, operating system images, and applications to the clients 18, 20, 22. The server 14 may act as an instant messaging server to facilitate the exchange of messages between various users and clients, such as the clients 18, 20, 22. The server 14 may be conventional, and may be provided with any generic instant messaging program. It is an advantage of some aspects of the present invention that messages can be exchanged and distributed among clients without modification to the instant messaging programs of the server 14, or its hardware.

### EMBODIMENT 1

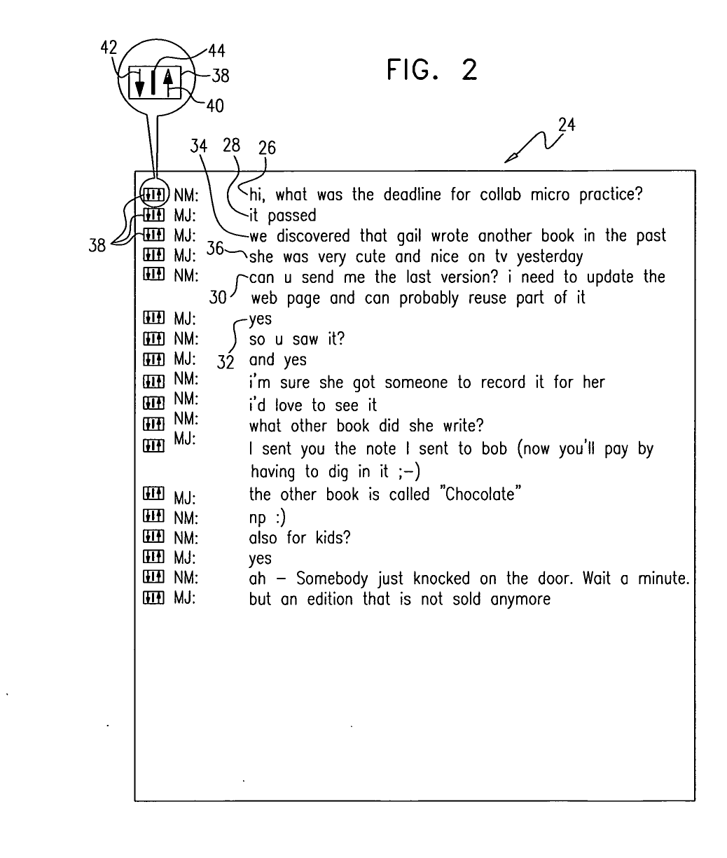

Reference is now made to FIG. 2, which is a pictorial diagram illustrating a window of a display showing a fragment of a chat transcript 24, in accordance with a disclosed embodiment of the invention. Participants in the chat are identified by screen names NM and MJ.

In a raw form of display, received and transmitted messages are simply presented in the order processed by the user's computer or communications device. Consequently, they may be displayed out of logical order, depending upon the response times of individual participants.

In one aspect of the invention, users are enabled to interchange the order of groups of messages, or individual messages, for example to push messages up, in order to place them in proximity to other messages having the same or similar context. This operation is commonly performed to clarify or otherwise clean up the transcript.

In the transcript 24 a group of messages 26, 28 deal with the issue of micro practice. A continuation of this line of conversation continues below in another group of messages 30, 32. Two messages 34, 36, unrelated to the discussion of micro practice, are interposed between the two groups. To rationalize the transcript, one of the participants may desire to relocate some of the messages.

Assume, for example, that the user desires to relocate the messages 30, 32 so that they are contiguous with the messages 26, 28. This can be performed by selecting the messages 30, 32 by right-clicking the selection and then selecting a “push up” operation from a popup window.

Additionally or alternatively, each message may be provided with an individual control 38, which when left-clicked, cause the message to be displaced upward or downward in order, according to whether an upwardly directed arrow 40 or a downwardly directed arrow 42 is actuated. The control 38 may be provided with an icon 44, which can be assigned to additional functions, as described below. Selection of the arrow 40 within any control 38 of the selection will cause the entire group of messages 30, 32 to be displaced upward.

When a message is selected for reordering, an ancillary visual indicator is activated automatically. For example, the selected message can be highlighted, bolded, changed to another color, or caused to flash. The ancillary visual indicator displays temporarily. It may disappear when expressly disabled by the user, when other users become aware of the new order, or after a timeout interval has elapsed. Other participants in the chat also see the ancillary visual indicator, and they can thus become aware that the messages have been reordered. Additionally or alternatively, an auditory cue may be activated to alert the participants that reordering is in progress.

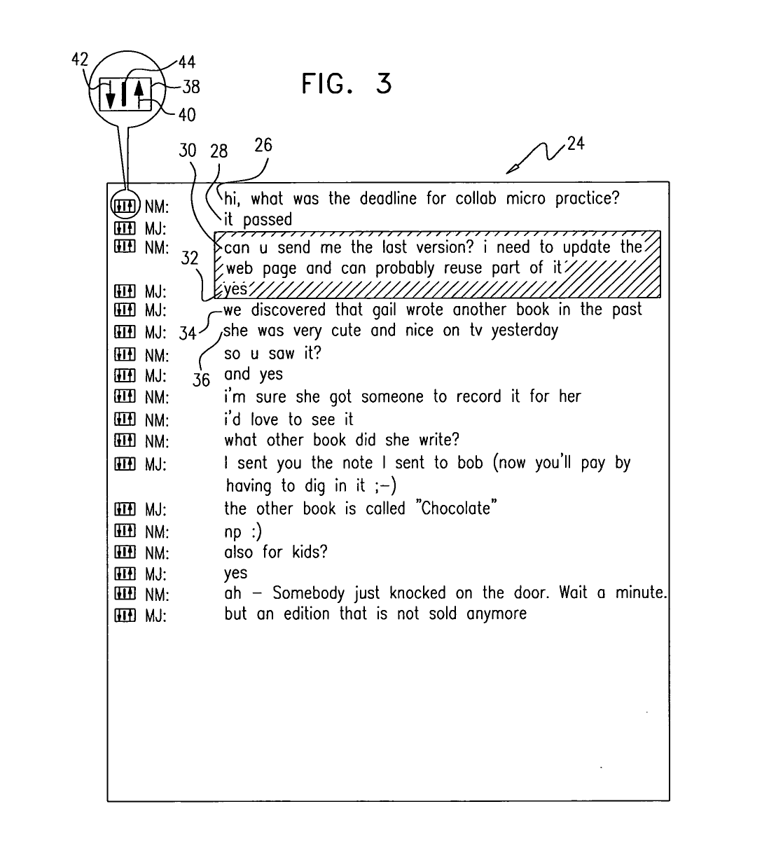

Reference is now made to FIG. 3, which is a pictorial diagram illustrating a window of a display showing the chat transcript 24 (FIG. 2), in which the messages 30, 32 have been relocated, in accordance with a disclosed embodiment of the invention. The messages 30, 32 are now visually accentuated, in this case using an exemplary highlighting technique. However the accentuation will be removed shortly, and a reordered version of the transcript 24 then remains. The reordering operation and subsequent accentuation of the reordered message is displayed on the devices of other participants, provided that they have chosen appropriate configuration options.

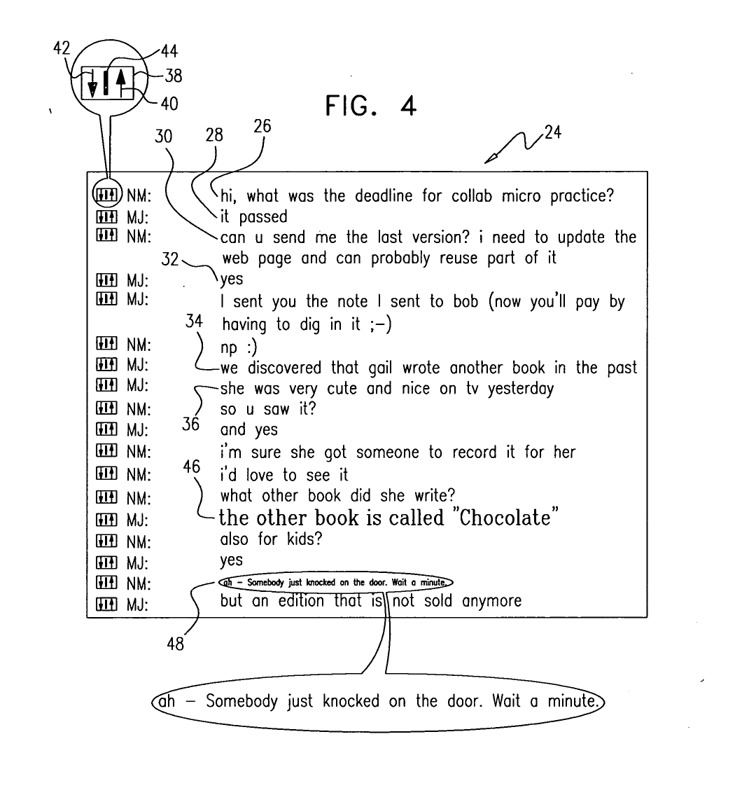

The reordering operation just described can be iterated until the entire transcript is in a desired order. Reference is now made to FIG. 4, which is a pictorial diagram illustrating a fully reordered version of the chat transcript.

Reordering chat messages is especially important when records of persistent chat are preserved. The term “persistent chat” refers to an enduring chat session. When reviewing a transcript of persistent chat, late readers usually do not care about the original order of the messages, but need to understand the outcome of the chat.

### EMBODIMENT 2

In one embodiment of the invention, users are enabled to set off or emphasize an existing chat message in the transcript, if they want to draw attention to it. For instance, a user may want to discuss a specific message that was sent in the past. Continuing to refer to FIG. 4, a user has determined that a message 46 is deserving of particular attention, or perhaps has realized that the other chat participants missed the message 46. The message 46 has now been given an emphasis effect by bolding, and by increasing its font size. The emphasis effect is temporary by default, and disappears when expressly disabled by the user, when other users indicate that they have become aware of the emphasis, or after a timeout interval has elapsed. However, it can be designated to persist. To emphasize a message, the user may right-click on the message or on the icon 44 of the associated control 38 and then select an emphasis option from a popup menu. The emphasis effect provided for the message 46 is merely exemplary, and other techniques for emphasizing messages may be used, additionally or alternatively, according to the user's preference. For example, a visual highlight, e.g., color or flashing effects may be employed. In any case, the message is brought to attention, even if it is deeply buried within an extensive transcript. Indeed, a gradation of emphasis techniques can be employed, according to the importance or urgency placed by the user on the particular message being emphasized. Furthermore, temporary audio effects may be introduced to enhance the visual emphasis effect, e.g., a continuous or pulsatile tone.

### EMBODIMENT 3

In another aspect of the invention, users may additionally or alternatively be assisted in preparing the chat transcript for persistence. Typically, some messages in a transcript are “control messages” that simply allow users to coordinate their chat session, e.g., a message “did you see this message?” along with a visually accentuating feature or action. Other messages may simply be inconsequential to the topic, e.g., small talk. In this embodiment, users are enabled to de-emphasize messages. Referring again to FIG. 4, a message 48 has been determined to be suitable for de-emphasis. Its font size is reduced, so that it appears less conspicuous than its neighbors.

Additionally or alternatively, de-emphasis can be achieved by “graying-out” the message. The font style of de-emphasized messages could also be changed in order to make them even more inconspicuous. Thus, during the chat, they do not catch much attention. A further advantage of this embodiment is the ability to easily identify and remove de-emphasized messages when editing the stream in order to preserve a more meaningful record of the chat.

Implementation Details.

In general, participating chat clients exchange messages, usually via a server. The message payload typically includes a text string to be appended to a text box displaying the chat session. Some versions also contain a list of attributes, such as font size and color, to be applied to the text. In yet other versions, a message mechanism is used to send commands to a remote client, for example triggering the playing of an audio snippet.

The chat software, necessary to support chat sessions according to the invention, uses similar mechanisms. No modifications to the server, which relays the messages between the clients, are necessary.

To support re-ordering and topic association of chat text displayed in the text-box, the client maintains the chat strings in a data structure, which can be a linked list. The data structure typically includes a message identifier, which clients may use as a reference when reordering the message, or otherwise handling the message as disclosed herein. Other suitable data structures will be apparent to those skilled in the art. The data structure need not be populated until reordering is invoked, in which case the content of the text box is parsed. Subsequent chat text is added to the data structure as well as the text-box. Alternatively, the data structure could be repopulated whenever needed. As there are tradeoffs between the frequency of repopulation and reordering, response time of the system, and available storage space, flexibility is provided in this regard. Any re-ordering, re-coloring, i.e., a change of topic association of previous chat text, or visual accentuation by one user triggers a control command to be sent to other participants causing their clients to reflect the change.

Operation.

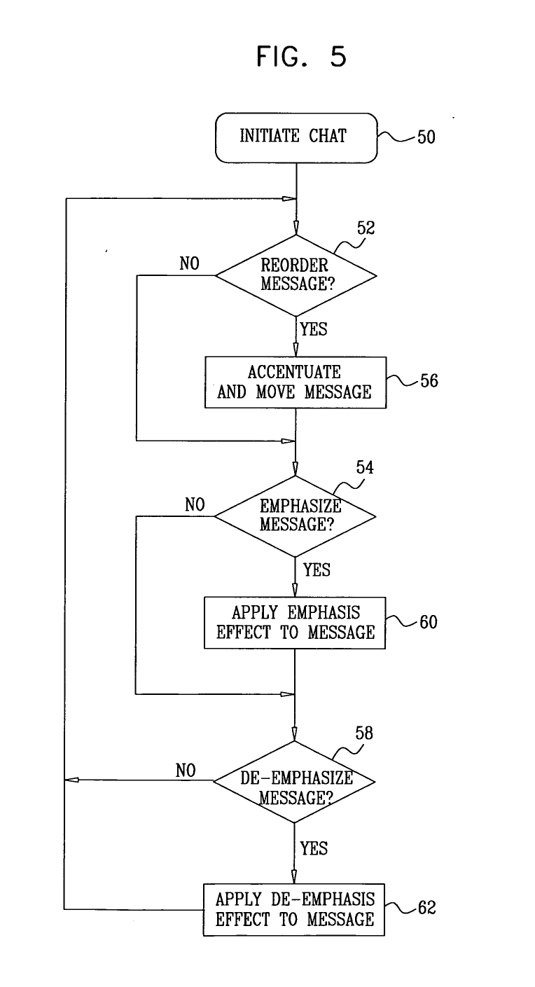

Reference is now made to FIG. 5, which is a flow chart illustrating a method of chat in accordance with a disclosed embodiment of the invention. The process steps are shown in a linear sequence in FIG. 5 for clarity of presentation. However, it will be evident that many of them can be performed in parallel, asynchronously, or in different orders.

At initial step 50 any number of participants agree to chat with one another using a networked system of computers. This may be done conventionally, i.e., by entering a “chat room” on the Internet.

Control now proceeds to decision step 52, where it is determined if a chat message is to be reordered. This determination can be made by any participant. If the determination at decision step 52 is negative, then control proceeds to decision step 54, which is described below.

If the determination at decision step 52 is affirmative, then control proceeds to step 56. A message is selected, and highlighted or otherwise accentuated. The selected message is moved up or down in the chat window to a desired position. The actions are propagated to and reflected in the chat windows of other chat participants who have configured their clients accordingly.

Following performance of step 56, or if the determination in decision step 52 is negative, control proceeds to decision step 54, where it is determined if a message needs to be emphasized. If the determination at decision step 54 is negative, then control proceeds to decision step 58, which is described below.

If the determination at decision step 54 is affirmative, then control proceeds to step 60. A message is selected and a highlighting or other emphasis effect applied, using one or more of the alternatives discussed above in Embodiment 2. The actions taken are propagated to and reflected in the chat windows of other chat participants who have configured their clients accordingly.

Following performance of step 60, or if the determination in decision step 54 is negative, control proceeds to decision step 58, where it is determined if a message needs to be de-emphasized. If the determination at decision step 58 is negative, then control returns to decision step 52, and the process iterates.

If the determination at decision step 58 is affirmative, then control proceeds to step 62. A message is selected and a de-emphasis effect is applied, using one or more of the alternatives discussed above in Embodiment 3, e.g., graying-out the selected message. The actions taken are propagated to and reflected in the chat windows of other chat participants who have configured their clients accordingly.

Following performance of step 62, or if the determination in decision step 58 is negative, control returns to decision step 52, and the process iterates.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method of chat communication among participants comprising the steps of:
displaying a sequence of chat communication messages in a window of a screen;
reordering said sequence of said chat communication messages in said window to create a new window display by relocating selected ones of said chat communication messages to desired positions; and
propagating said new window display to others of said participants in said chat communication.

2. The method according to claim 1, wherein reordering said sequence of chat communication messages comprises relocating said selected ones of said chat communication messages with respect to others of said chat communication messages.

3. The method according to claim 1, further comprising the steps of:
identifying said selected ones of said chat communication messages by an ancillary visual indicator in said window, wherein said ancillary visual indicator is not present in said window during periods in which said step of reordering is not being performed; and
transmitting control messages to said other participants indicative of said reordering.

4. The method according to claim 1, wherein said step of reordering comprises actuating controls on said window that are respectively associated with said chat communication messages.

5. The method according to claim 1, wherein said step of reordering comprises right-clicking on said chat communication messages to display a popup menu and selecting a relocation option from said popup menu.

6. The method according to claim 1, wherein said participants in said chat communication comprise clients that are linked to a server in a data network.

7. A method of chat communication among participants comprising the steps of:
displaying chat communication messages in a window;
visually emphasizing selected ones of said chat communication messages in said window to create a new window display; and
propagating said new window display to others of said participants in said chat communication.

8. The method according to claim 7, further comprising the step of identifying said selected ones of said chat communication messages on said new window display by triggering audio effects that are perceptible by said participants.

9. The method according to claim 7, wherein said step of emphasizing comprises actuating controls on said window that are respectively associated with said chat communication messages.

10. The method according to claim 7, wherein said step of emphasizing comprises right-clicking on said chat communication messages to display a popup menu and selecting an emphasis option from said popup menu.

11. The method according to claim 7, wherein said step of emphasizing comprises varying a font style of said selected ones of said chat communication messages.

12. The method according to claim 7, wherein said step of emphasizing comprises varying a color of said selected ones of said chat communication messages.

13. A method of chat communication among participants comprising the steps of:
displaying chat communication messages in a window;
visually de-emphasizing selected ones of said chat communication messages in said window to create a new window display; and
propagating said new window display to others of said participants in said chat communication.

14. The method according to claim 13, wherein said step of de-emphasizing comprises graying-out said selected ones of said chat communication messages.

15. The method according to claim 13, wherein said step of de-emphasizing comprises varying a font style of said selected ones of said chat communication messages.

16. The method according to claim 13, wherein said step of de-emphasizing comprises varying a color of said selected ones of said chat communication messages.

17. The method according to claim 13, wherein said step of de-emphasizing comprises actuating controls on said window that are respectively associated with said chat communication messages.

18. The method according to claim 13, wherein said step of de-emphasizing comprises right-clicking said chat communication messages to display a popup menu and selecting a de-emphasis option from said popup menu.

19. A computer software product for conducting chat communication among participants, including a computer-readable medium in which computer program instructions are stored, which instructions, when read by a computer, cause the computer to display a sequence of chat communication messages in a window of a screen; to reorder said sequence of said chat communication messages in said window to create a new window display by selecting said chat communication messages and relocating said selected ones of said chat communication messages to desired positions with respect to others of said chat communication messages, and to propagate said new window display to at least a portion of said participants in said chat communication.

20. The computer software product according to claim 19, wherein said instructions further cause said computer to identify said selected ones of said chat communication messages by displaying an ancillary visual indicator in said window, wherein said ancillary visual indicator is present only while relocating said selected ones of said chat communication messages, and to transmit control messages to said portion of said participants.

21. The computer software product according to claim 19, wherein said instructions further cause said computer to display controls on said window that are respectively associated with said chat communication messages, which controls, when actuated, cause said chat communication messages to be relocated on said window.

22. The computer software product according to claim 19, wherein said instructions further cause said computer to visually emphasize a portion of said chat communication messages in said window in said new window display.

23. The computer software product according to claim 19, wherein said instructions further cause said computer to visually de-emphasize a portion of said chat communication messages in said window in said new window display.

24. A data processing system for chat communication, comprising:
a client device linked to other devices via a server in a data network, wherein said server is operative to automatically distribute data among said client device and said other devices;
a memory accessible by said client device; and
a software program in said memory comprising program instructions, which instructions, when read by said client device, cause said client device to display a sequence of chat communication messages in a window, to enable a user of said client device to reorder said sequence of said chat communication messages in said window to create a new window display by selecting said chat communication messages and relocating said selected ones of said chat communication messages to desired positions with respect to others of said chat communication messages, and to propagate said new window display to at least a portion of said other devices via said data network.

25. The data processing system according to claim 24, wherein said instructions further cause said client device to identify said selected ones of said chat communication messages by displaying an ancillary visual indicator in said window, wherein said ancillary visual indicator is present only while relocating said selected ones of said chat communication messages, and to transmit control messages to said portion of said other devices.

26. The data processing system according to claim 24, wherein said instructions further cause said client device to display controls on said window that are respectively associated with said chat communication messages, which controls, when actuated by said user, cause said chat communication messages to be relocated on said window.

27. The data processing system according to claim 24, wherein said instructions further cause said client device to visually emphasize a portion of said chat communication messages in said window in said new window display.

28. The data processing system according to claim 24, wherein said instructions further cause said client device to visually de-emphasize a portion of said chat communication messages in said window in said new window display.
